(19) United States
(12) Patent Application Publication
(10) Pub. No.: US 2008/0266165 A1
(43) Pub. Date: Oct. 30, 2008

(54) SYSTEM FOR DEPLOYMENT OF A MILLIMETER WAVE CONCEALED OBJECT DETECTION SYSTEM

(76) Inventors: ROBERT PATRICK DALY, Orlando, FL (US); Willem H. Reinpoldt, Windermere, FL (US)

Correspondence Address: McKinney Law, LLC, 390 N. Orange Avenue, Suite 2300, Orlando, FL, 32801, US

(21) Appl. No.: 12/110,520

(22) Filed: Apr. 28, 2008

Related U.S. Application Data
(60) Provisional application No. 60/914,332, filed on Apr. 27, 2007.

(51) Int. Cl. G01S 13/00; B65D 88/12

(52) U.S. Cl. 342/22; 292/251.5; 220/1.5; 340/5.82

(57) ABSTRACT

A system for deployment of a millimeter wave concealed object detection system is disclosed. In a particular embodiment, a storage container modified as a security check point includes an entry point disposed at a first end of the container and an exit point disposed at an opposing second end of the container. A detection area is disposed within the container and between the entry point and exit point. The detection area is isolated from the entry point and exit point so that an explosive blast is substantially contained within the detection area of the container. The system provides a standard platform for deployments of concealed object detection systems across extremely variable environments.

### I. CROSS REFERENCE TO RELATED APPLICATIONS

This application claims the benefit of U.S. Provisional Application No. 60/914,332 filed Apr. 27, 2007. The disclosure of the provisional application is incorporated herein by reference.

### II. FIELD

The present disclosure relates generally to the field of deployment systems, and in particular to a system for the deployment of a millimeter wave concealed object detection system used for the detection of concealed objects such as weapons and stolen merchandise.

### III. DESCRIPTION OF RELATED ART

Security systems can be found at airports, train stations, arenas, construction sites, and other public, private, commercial and industrial facilities. In addition, security systems are used in field military operations to secure boundaries. One of the principal concerns of operators of security systems is the need to protect security personnel and innocent bystanders in the course of conducting a search of a person for concealed objects. The concealed objects that present a danger are weapons, explosives, contraband and other similar items that may endanger security personnel and other individuals in the proximity.

Typical metal or chemical residue detectors require security personnel to be in the proximity of the individual. For example, one or more security personnel are required to conduct a hands-on or “wand-based” scan of an individual for whom the metal or chemical residue detector has generated an alarm. An inherent deficiency of this type of security system is the fact that it exposes not only the security personnel to danger, but also other individuals in the vicinity of the security system to the dangers posed by such concealed objects. Passive millimeter wave concealed object detection systems have been developed that allow for a buffer zone between the individual and innocent bystanders. However, there is still a concern that when a concealed object is detected on a person, that the person may attempt to escape the area or injure others in the proximity using an explosive device (i.e., suicide bomber). Accordingly, there is a need in the relevant art for a system for deployment of a millimeter wave concealed object security system that has the ability to protect security personnel and innocent by-standers from any potential threat or danger from a concealed object.

Another need exists in the art for a system for the deployment of a millimeter wave concealed object detection system that is suitable for imaging systems utilizing various forms of energy including millimeter waves, radio waves, visible light, infrared, ultraviolet, microwave energy.

Another need exists in the art for a system for the deployment of a millimeter wave concealed object detection system that uses an International Organization for Standardization (ISO) storage container to serve as a transportable access control point.

Another need exists in the art for a system for the deployment of a millimeter wave concealed object detection system that increases the number of individuals that are screened.

Another need exists in the art for a system for the deployment of a millimeter wave concealed object detection system having maximum separation of screened persons and unscreened persons as well as the ability to closely deploy multiple containers in a side-by-side fashion.

Another need exists in the art for a system for the deployment of a millimeter wave concealed object detection system having an environmentally-engineered internal configuration and construction allowing for a highly controlled inspection environment.

However, in view of the prior art at the time the present invention was made, it was not obvious to those of ordinary skill in the pertinent art how the identified needs could be fulfilled.

### IV. SUMMARY

In a particular embodiment, a system for the deployment of a millimeter wave concealed object detection system is disclosed. The system includes pre-engineered and pre-manufactured components to effectively control the deployment surroundings and provide a known and successful environment in which the millimeter wave equipment can operate. The system further includes an ISO storage container, modified as a security check point with exposed entry and exit barriers on the sides of the container.

In another particular embodiment, the system for the deployment of a millimeter wave concealed object detection system includes an ISO storage container, modified as a security check point with slide-out entry and exit barriers on the ends of the container.

In another particular embodiment, the system for the deployment of a millimeter wave concealed object detection system includes multiple check point lanes in a single modified ISO storage container with or without barriers.

One particular advantage provided by embodiments of the system for the deployment of a millimeter wave concealed object detection system is that the components, techniques, designs and construction separately, or in combination, provide an advantageous, predictable, controlled and managed environment within which the concealed weapons/object detection system operates optimally. Another advantage provided by embodiments of the system is that the need to adapt the system's cameras to an uncontrolled environment is eliminated.

Another particular advantage provided by embodiments of the system for the deployment of a millimeter wave concealed object detection system is that the system provides an easy method of removing the deployment from one location and re-deploying in another location. In addition, the system simplifies training and ease of use owing to the fact that each deployment is the same as another in contrast to a customized/unique deployment for each installation.

Another advantage provided by embodiments of the system is that the need to ship and store multiple components and construction articles is eliminated by employing a prefab, turn-key design without having to custom engineer a deployment solution for each application. Accordingly, the turn-key design of the system simplifies the replacement of a damaged container due to an explosives detonation, for example. Another particular advantage of the system for the deployment of a millimeter wave concealed object detection system is that a stable, standard platform is provided for deployments across extremely variable environments, resulting in lower installation costs and time, and simpler construction and support. Further, the system allows for a realization of manufacturing, engineering and procurement cost savings due to economies of scale.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is an exit perspective view of a particular illustrative first embodiment of a system for the deployment of a millimeter wave concealed object detection system with a top and side panel removed for clarity;

FIG. 2 is an entrance perspective view of a particular illustrative first embodiment of a system for the deployment of a millimeter wave concealed object detection system with the top and side panel removed for clarity;

FIG. 3 is a top view of a particular illustrative first embodiment of a system for the deployment of a millimeter wave concealed object detection system with the top panel removed for clarity;

FIG. 4 is an exit perspective view of a particular illustrative second embodiment of a system for the deployment of a millimeter wave concealed object detection system with a top and side panel removed for clarity;

FIG. 5 is an entrance perspective view of a particular illustrative second embodiment of a system for the deployment of a millimeter wave concealed object detection system with the top and side panel removed for clarity;

FIG. 6 is a top view of a particular illustrative second embodiment of a system for the deployment of a millimeter wave concealed object detection system with the top panel removed for clarity;

FIG. 7 is an exit perspective view of a particular illustrative third embodiment of a system for the deployment of a millimeter wave concealed object detection system with a top and side panel removed for clarity;

FIG. 8 is an entrance perspective view of a particular illustrative third embodiment of a system for the deployment of a millimeter wave concealed object detection system with the top and side panel removed for clarity;

FIG. 9 is a top view of a particular illustrative third embodiment of a system for the deployment of a millimeter wave concealed object detection system with the top panel removed for clarity;

FIG. 10 is an exit perspective view of a particular illustrative fourth embodiment of a system for the deployment of a millimeter wave concealed object detection system with a top and side panel removed for clarity;

FIG. 11 is an entrance perspective view of a particular illustrative fourth embodiment of a system for the deployment of a millimeter wave concealed object detection system with the top and side panel removed for clarity;

FIG. 12 is a top view of a particular illustrative fourth embodiment of a system for the deployment of a millimeter wave concealed object detection system with the top panel removed for clarity;

FIG. 13 is an entrance perspective view of a particular illustrative fifth embodiment of a system for the deployment of a millimeter wave concealed object detection system;

FIG. 14 is an exit perspective view of a particular illustrative fifth embodiment of a system for the deployment of a millimeter wave concealed object detection system;

FIG. 15 is a top view of an entrance perspective view of a particular illustrative sixth embodiment of a millimeter wave concealed object detection system; and

FIG. 16 is an exit perspective view of the particular illustrative embodiment of the system shown in FIGS. 1-3 with the side and top panels installed.

### VI. DETAILED DESCRIPTION

A system for deploying a concealed object detection system using pre-engineered and pre-manufactured components is disclosed. The system provides effective control of deployment surroundings and provides a known and successful environment in which the millimeter wave equipment can operate. Several components, techniques, technologies and methodologies including external millimeter wave energy mitigation, peripheral motion or clutter mitigation, test subject isolation, motion and flow control, threat containment, weather protection, decorative presentation, blast mitigation, and others may each be used separately, or in combination, with the system.

In addition, the system includes multiple implementations and realizations. One particular embodiment provides an ISO storage container, modified as a security check point with exposed entry and exit barriers on the sides of the container. The container may include blast hatches, stress points or other blast mitigation devices or techniques. In another embodiment, the system provides slide-out entry and exit barriers on the ends of the container. In yet another particular embodiment, the system provides multiple check point lanes in a single modified ISO storage container with or without barriers. The system includes engineered solutions for wall construction, flooring, lighting, ambient millimeter wave energy mitigation, flow/traffic control, weather protection, decorative presentation, threat containment, blast mitigation, and reduction of peripheral visual/millimeter wave clutter. Internally and/or externally mounted heating, cooling or ventilation devices, or a combination thereof are also provided. A bulkhead may be provided at either the entrance of the container, the exit of the container, sides of the container or any combination thereof for use with power connection, utilities connection, heating/cooling/ventilation (HVAC) venting, computer wiring, communications wiring, etc. However, the system may also include external access points not attached to the bulkhead for connection to power, utilities, heating/cooling/ventilation (HVAC) venting, computer wiring, communications wiring, etc.

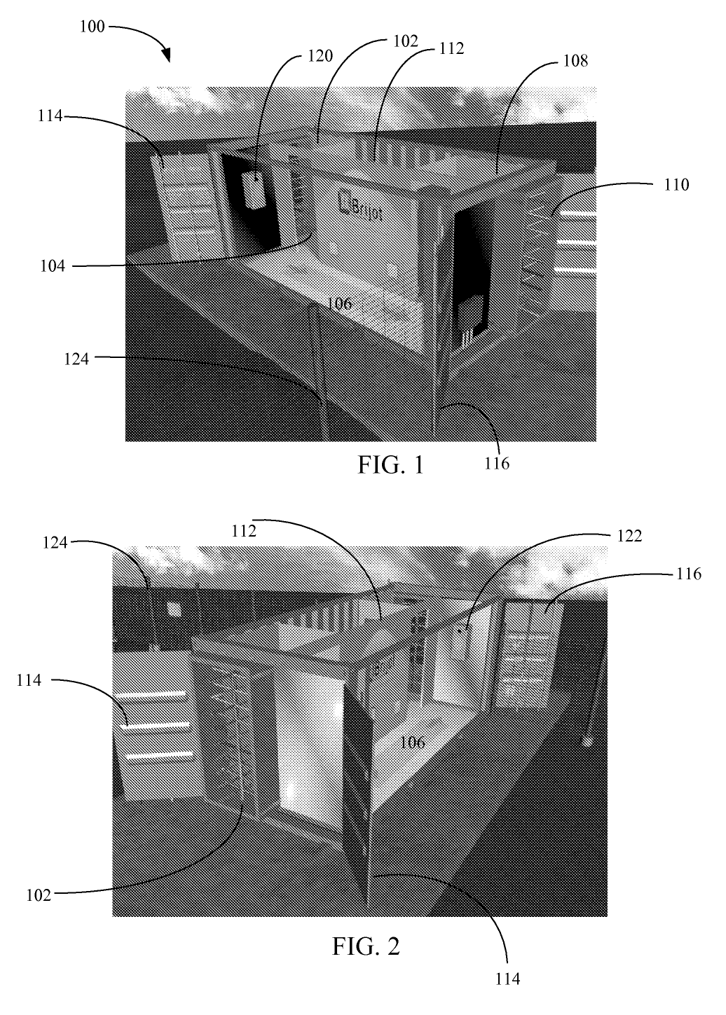

Referring to FIGS. 1-3, a particular illustrative embodiment of a system for the deployment of a millimeter wave concealed object detection system is disclosed. The disclosed system is based on a modified and customized ISO storage container generally designated 100 with optional flush mount or slide-out entry 102 and exit barriers 110 located at the ends of the container 100. Accordingly, the standard ISO container doors 114, 116 can be retained and used for enclosing and protecting the modified aspects of the container during shipping, storage and severe weather, or to protect the contents of the container from theft, when not in use, or in times of civil unrest. To simplify and optimize multiple container deployments, the container doors 114, 116 may include a hinge design that allows the doors to be lifted off their hinges, or similarly be made to be easily removable, so that additional containers can be placed side-by-side and touching for minimum floor space requirements and maximum security protection (e.g., no access between containers).

The system can be deployed in manners consistent with other ISO storage containers such as by train, truck and ship. Power, utility, computer and communications lines are connected using pre-wired connections. Any shipping straps or protection is removed from external vents and blast hatches of the container 100. Optional fencing 124 is erected outside of the container to further separate the un-screened public from the screened public. The entry and/or exit barriers 102, 110 are either extended by virtue of a slide-out mechanism or otherwise physically attached to the threshold or outside of the container 100.

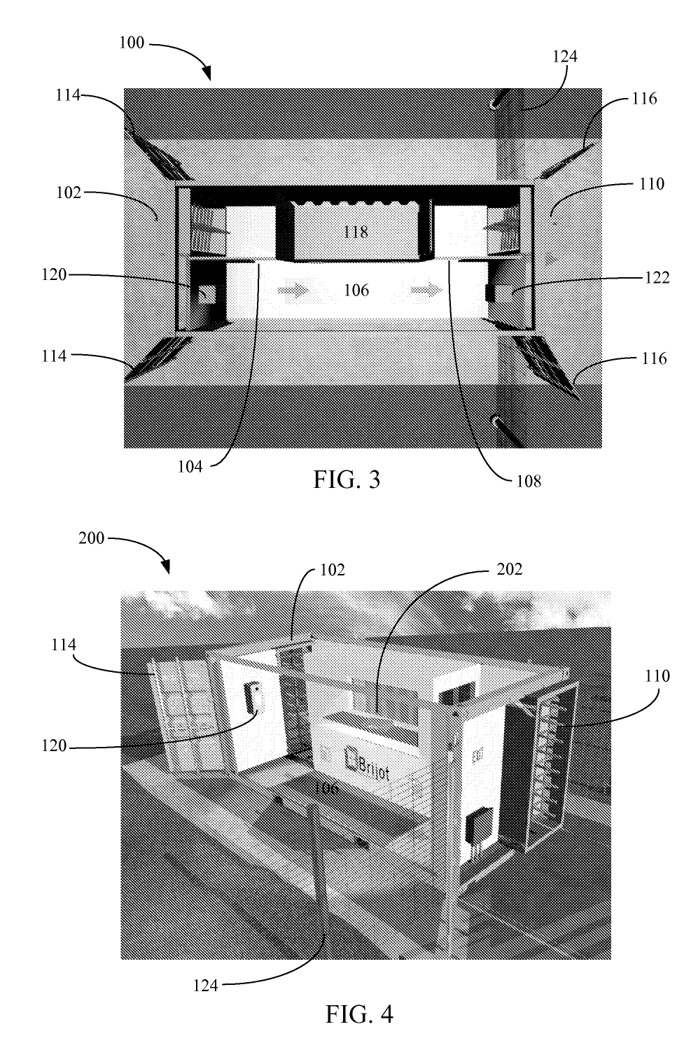

Referring now to FIG. 3, the subject enters the container 100 through a controlled access outer entryway 102 such as a magnetic-locking door or full body turnstile. Upon entry, the controlled access outer entry and exit points 102, 110 lock, securing the subject in the container 100. The subject then passes through an optional inner entryway 104 to the detection area 106 to the optional inner exit way 108 while being monitored by the system's weapons/object detection camera(s) 120, 122. A partition 112 divides the container 100 to form the detection area 106. One or more weapons/object detection cameras are provided. The outer entryway 102 and outer exit 110 are offset from the detection area 106 so that in the event of an explosion, the blast is substantially contained within the detection area 106. A monitoring area 118 is provided to host internal security personnel, or more typically will include an internal intercom system allowing external security personnel to remotely communicate with subjects inside the container while viewing the subject via the weapons/object detection system's internal camera and/or ancillary cameras or devices, thus providing “stand-off” protection from explosive detonations. In this case, monitoring area 118 can be used as a storage area and/or contain HVAC (heating, ventilation, air condition) equipment, PLC (programmable logic controller) equipment, or other uses.

For single weapons/object detection camera deployments, the subject may be commanded to stop and turn in front of the weapons/object detection camera before continuing. For multiple weapons/object detection camera deployments, the subject either continues undisturbed past the weapons/object detection cameras at a normal walking pace, or is required to stop and stand in front of the weapons/object detection cameras 120, 122 before continuing. If a threat is not detected by the system's weapons/object detection camera(s) 120, 122, the subject exits the detection area 106 and the controlled access outer exit point 110 will unlock and allow the subject to exit the container.

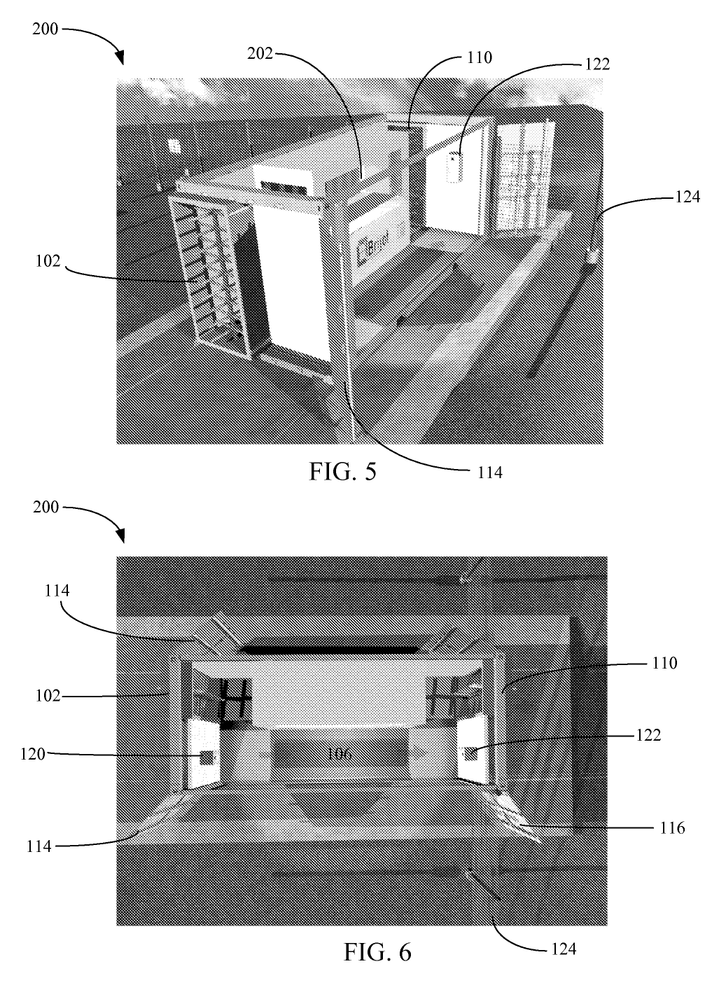

Referring now to FIGS. 4-6, a second embodiment of the system for deploying a concealed object detection system is generally designated as 200. An accessory scanning area 202 that is adjacent to the detection area 106 is used to detect concealed objects that may pose a threat and are hidden in accessories carried by a subject. As the subject enters through the inner entryway 104 to the detection area 106, the subject places his or her accessory (e.g., briefcase) on a platform such as a moving conveyor belt, for example. The accessory is scanned for potential threats by suitable technology such as an x-ray baggage screening machine, trace explosives detector, or similar device.

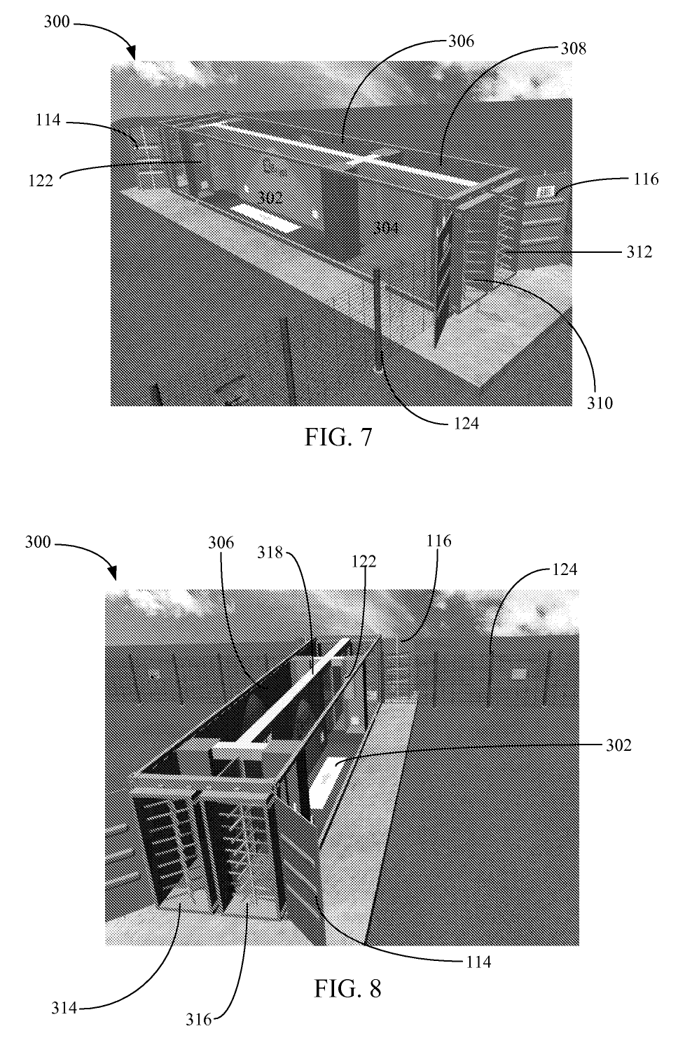

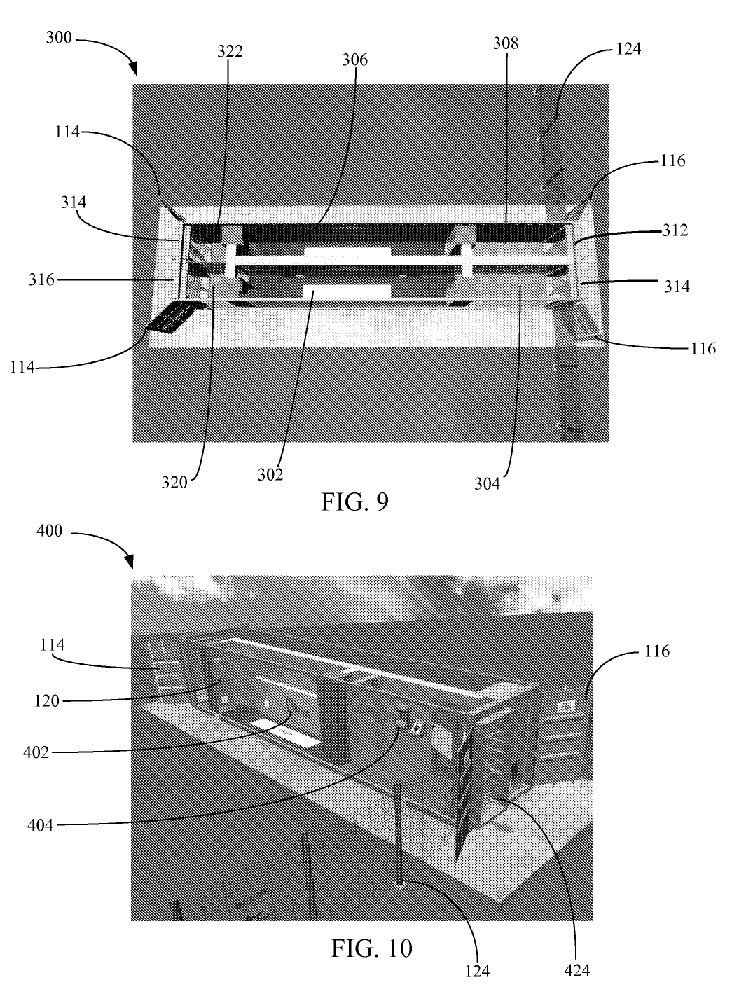

Referring now to FIGS. 7-9, a third embodiment of the system for deploying a concealed object detection system is generally designated as 300. A first detection area 302 is adjacent to a second detection area 306 to increase the rate of processing subjects through the millimeter wave concealed object detection system. A partition 318 divides the container 300 into a first and second lane. Each lane has its own outer entry point (314, 316), inner entryway (320, 322), a detection area (302, 306), an inner exit (304, 308) and an outer exit point (310, 312), respectively. A subject can enter either the first lane or second lane.

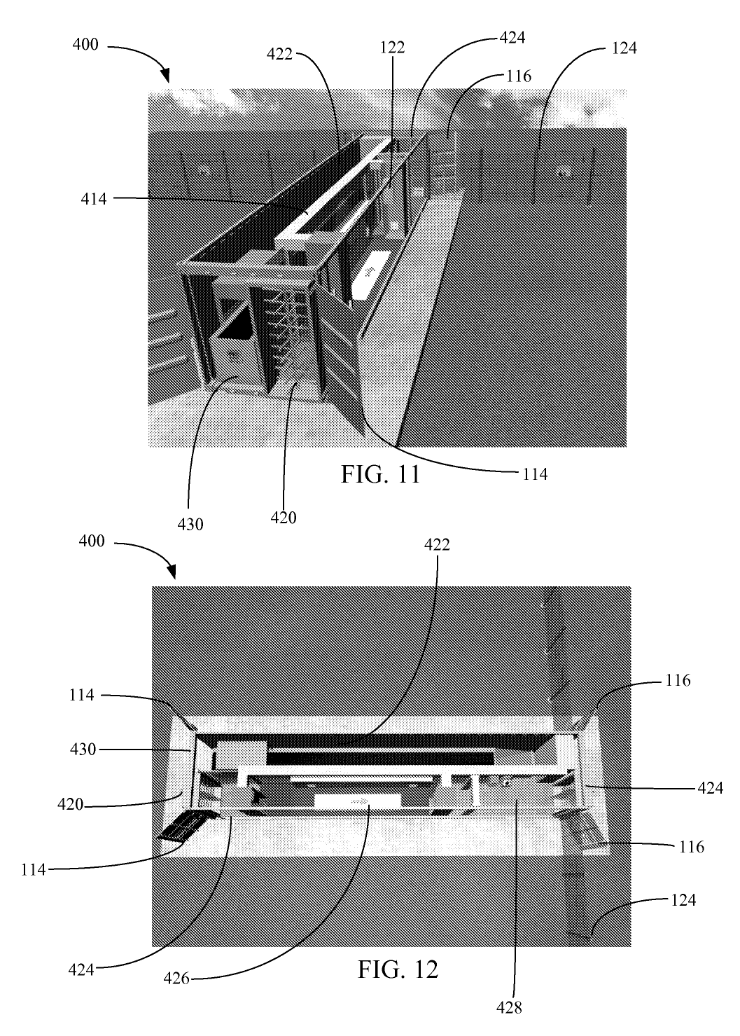

A fourth embodiment of the system for deployment of a millimeter wave concealed object detection system is generally designated as 400 as illustrated in FIGS. 10-12. The system can include complementary products such as x-ray machines, iris scanners, biometrics, finger readers, palm readers, metal detectors, and access control cards. For example, complementary biometrics products 404 are installed in the container 400. The entry point 420 and exit point 424 remains locked until the subject successfully passes the biometrics criteria such as iris scan, fingerprint, palm print, voice recognition, etc. If a threat is detected by the system's threat/object detection cameras, or if the subject does not pass the biometric criteria, the controlled access entry point 420 and exit point 424 do not unlock thereby preventing the subject from exiting the container 400.

A first end of a conveyor belt 430 is provided at the entry point 420 wherein the conveyor belt 430 passes through the length of the container 400 to the exit point 424 via an accessory scanning area 422. The accessory scanning area 422 is adjacent to the detection area 426 and is used to detect concealed object that may pose a threat and are hidden in accessories carried by a subject. A partition 414 provides a barrier between the accessory scanning area 422 and the detection area 426. In this particular embodiment, the subject places his or her accessory (e.g., briefcase) on the conveyor belt 430 before entering through the entry point 420. As the subject enters through the inner entryway 424 to the detection area 426, the accessory is also being scanned by the x-ray baggage screening machine or other type of detection system for potential threats.

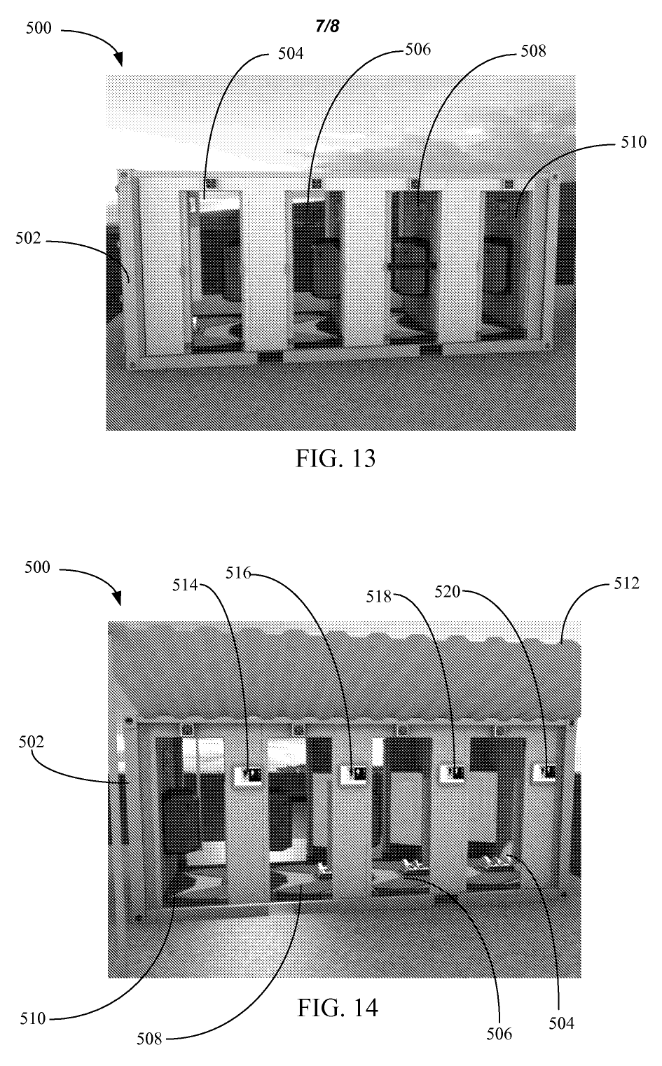

Referring now to FIGS. 13 and 14, a fifth particular embodiment of the system for deploying a concealed object detection system is generally designated as 500. Multiple entry points are provided on one side of the container 502 as opposed to an end of the container as described above. Multiple detection areas and lanes (504, 506, 508, 510) are provided to increase the rate of processing subjects through the millimeter wave concealed object detection system. A partition disposed between each detection lane divides the container 502 into multiple lanes. The container 502 is provided with flush mount entry/exit barriers, slide-out entry and exit barriers, no entry/exit barriers, or a combination thereof located on the sides of the container 502. Each detection lane has its own display (514, 516, 518, 520) for viewing the millimeter wave imagery, among other things, and for detecting concealed objects, or the displays may be combined in some combination. The detection lanes may be equipped with either a common or a dedicated entry and/or exit barrier or a dedicated inner exit point, which may be controlled (magnetic locking door, controlled turnstile, etc), uncontrolled (isolation curtain, manual door), or both.

Each detection lane (504, 506, 508, 510) may be equipped with complimentary equipment such as magnetometer, explosives trace detector or biometrics. While four detection lanes are depicted in FIGS. 13 and 14, the actual number of detection lanes can be varied.

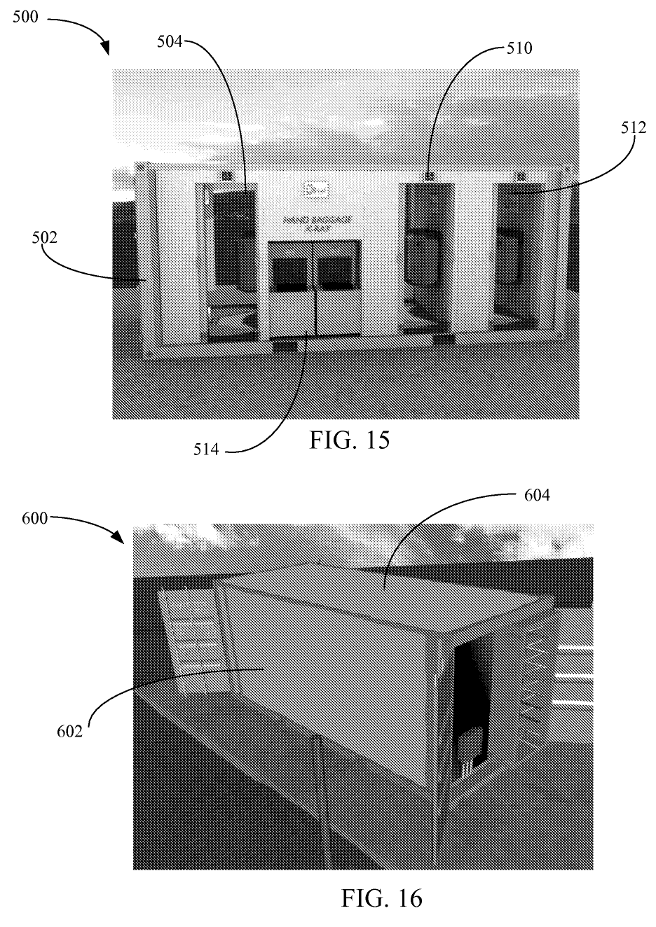

As illustrated in FIG. 15, a first end of an x-ray scanning apparatus 514 is provided at a first side of container 502 wherein the x-ray scanning apparatus 514 passes through the width of the container 502 (as opposed to the length as described above) to the exit point on the opposing second side of the container 502. Multiple partitions provide a barrier between the lanes (504, 510, 512) and the x-ray scanning apparatus 514. In this particular embodiment, the subject places his or her accessory (e.g., briefcase) on the x-ray scanning apparatus 514 before entering through one of the lanes (504, 510, 512). As the subject passes through the container 502, any accessory placed on the x-ray scanning apparatus 514 is also being scanned for potential threats, contraband or stolen objects.

Referring now to FIG. 16 is an exit perspective view of the particular illustrative embodiments of the system shown in FIGS. 1-3 with the side and top panels installed and enclosing the container. FIG. 16 is also provided as an example of the standard ISO containers provided for FIGS. 4-12. The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A system for deployment of a millimeter wave concealed object detection system, the system comprising:
a storage container modified as a security check point;
an entry point disposed at a first end of the container;
an exit point disposed at a second end of the container;
a detection area disposed within the container and between the entry point and exit point; and
a concealed object detection system that detects concealed objects passing through the detection area.

2. The system of claim 1 wherein the detection area is offset from the entry point and exit point so that in the event of an explosion therein that a blast is substantially contained within the detection area of the container.

3. The system of claim 1 wherein the container is an International Organization for Standardization (ISO) container.

4. The system of claim 1 wherein the entry point and exit point each further comprising a lockable full body turnstile.

5. The system of claim 1 wherein the entry point and the exit point each further comprising magnetic locking doors.

6. The system of claim 1 wherein the container further comprising removable doors that protect the entry point and exit point when closed.

7. The system of claim 1 further comprising:
an inner entryway to the detection area that provides a barrier between the detection area and the entry point; and
an inner exit way from the detection area that provides a barrier between the detection area and the exit point.

8. The system of claim 1 further comprising a separate monitoring area adjacent to the detection area to host internal security personnel.

9. The system of claim 1 wherein the concealed object detection system is a millimeter wave concealed object detection system having at least one millimeter wave camera.

10. The system of claim 1 further comprising an accessory scanning area that is adjacent to the detection area and used to detect concealed objects hidden in accessories.

11. The system of claim 1 further comprising fencing or other barrier erected outside of the container to segregate persons having passed through the detection area and cleared of dangerous concealed objects from unscreened persons.

12. A system for deployment of a millimeter wave concealed object detection system, the system comprising:
a storage container modified as a security check point wherein the container is divided into at least two separate lanes wherein each lane comprising;
an entry point disposed at a first end of the container;
an exit point disposed at a second end of the container;
a detection area disposed within the container and between the entry point and exit point; and
a concealed object detection system that detects concealed objects passing through the detection area.

13. The system of claim 12 wherein the container is an International Organization for Standardization (ISO) container.

14. The system of claim 12 wherein the entry point and exit point of each lane each further comprising a lockable full body turnstile.

15. The system of claim 12 wherein each entry point and exit point slide out from within the container and attach to a threshold of the container.

16. The system of claim 12 further comprising:
an inner entryway to the detection area that provides a barrier between the detection area and the entry point;
an inner exit way from the detection area that provides a barrier between the detection area and the exit point; and
wherein a blast is substantially contained within the detection area of the container in the event of an explosion therein.

17. The system of claim 12 wherein the concealed object detection system is a millimeter wave concealed object detection system having at least one millimeter wave camera.

18. The system of claim 12 further comprising complementary biometric devices for controlling each entry point and the exit point.

19. The system of claim 12 further comprising fencing or other barrier erected outside of the container to segregate persons having passed through the detection area and cleared of dangerous concealed objects from unscreened persons.

20. The system of claim 12 further comprising an accessory scanning device for detecting concealed objects hidden in accessories.

21. The system of claim 12 wherein each entry point and exit point are flush mounted to a threshold of the container.
